(19) United States
(12) Patent Application Publication
(10) Pub. No.: US 2013/0262171 A1
(43) Pub. Date: Oct. 3, 2013

(54) System and Method for Directing and Monitoring the Activities of Remote Agents

(71) Applicants: Peter Solodko, Sarasota, FL (US); Nicholas Solodko, Sarasota, FL (US)

(72) Inventors: Peter Solodko, Sarasota, FL (US); Nicholas Solodko, Sarasota, FL (US)

(73) Assignee: Solodko Properties, LLC, Sarasota, FL (US)

(21) Appl. No.: 13/992,401

(22) PCT Filed: Dec. 9, 2011
(86) PCT No.: PCT/US11/64192

§ 371 Date: Jun. 7, 2013

Related U.S. Application Data
(60) Provisional application No. 61/421,805, filed on Dec. 10, 2010.
(60) Provisional application No. 61/494,076, filed on Jun. 7, 2011.

(51) Int. Cl. G06Q 10/06; G06Q 50/00

(52) U.S. Cl. CPC G06Q 10/06311; G06Q 50/01
USPC 705/7.18; 705/7.13

(57) ABSTRACT

Systems and methods for directing activities of remote agents via a scheduling engine which generates a proposed schedule based on predetermined business rules, contact parameters for the target locations, and the geo-coded information of the target locations. The target locations have contacts to be visited by a remote agent. The schedule is transmitted by a remote activity manager to the remote agent's handheld unit via a wireless network. The schedule and the geo-coded information may be displayed via a use interface. The remote agent may supply visit information. The location of the handheld unit may be tracked at predetermined intervals in order verify the visit.

This non-provisional patent application claims priority to, and incorporates herein by reference U.S. Provisional Patent Application No. 61/421,805 filed Dec. 10, 2010, and U.S. Provisional Patent Application No. 61/494,076 filed Jun. 7, 2011.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of directing remote agents that visit remote locations, and in particular to a system and method adapted to direct and monitor the activities of healthcare marketers tasked with repeat visits to healthcare providers based on a recurring schedule.

### BACKGROUND OF THE INVENTION

Systems and methods for directing the activities of remote agents are known. Such systems and methods, however, have failed to provide an efficient means of scheduling visits, tracking actual activities of remote agents against proposed schedules, and allowing for feedback from the remote agents in the formation of future schedules. Accordingly, it is an object of the present invention to address these limitations by providing a method and system that distributes proposed visitation schedules to remote agents through handheld devices with location tracking capabilities and a user interface capable of both directing the activities of the remote agent and also accepting input regarding the status of those activities.

### SUMMARY OF THE INVENTION

The presently disclosed invention may be embodied in various forms, including a system, a method or computer readable medium for directing activities of a remote agent. Information about remote locations, where contacts are to be visited by remote agents, may be received by a remote activity manager from a source of remote locations. Target locations, which are a subset of the remote locations, may be further generated by the remote activity manager by filtering the remote locations based on geo-coded information of remote locations. For example, the targeted locations may consist of remote locations within a particular region targeted by a remote agent. In addition, generation of the target locations may be based on specialties of the contacts.

A scheduling engine may generate a schedule based on pre-determined business rules, contact parameters for the target locations, and the geo-coded information for the target locations. The schedule may be transmitted to a handheld unit of the remote agent. The handheld unit may be a programmable device comprising a GPS receiver. The schedule may be transmitted by the remote activity manager as the remote activity manager is adapted to communicate with the handheld unit via a long range wireless network. The schedule may be displayed via a user interface for the handheld unit. The handheld unit of the remote agent may be a device such as a personal digital assistant, a Blackberry, a Palm Pilot, a tablet and a laptop.

In an embodiment, the contact parameters for the target locations may be determined based on contact characteristics of the contacts. The contact parameters may include corresponding visit frequencies.

Geo-coded information of the handheld unit for the remote agent may also be tracked as the remote agent visits the target locations. Updated contact information for visited locations may be collected. The visited locations may be a subset of the target locations. The updated contact information may be collected via the user interface for the handheld unit.

The updated contact information and the tracked geo-coded information may be transmitted to the remote activity manager. The contact parameters for the visited locations may be updated based on the updated contact information. The updated contact parameters may include updated visit frequencies for the visited locations.

According to an embodiment, the scheduling engine may update the schedule based on pre-determined business rules, the updated contact parameters for the visited locations, the updated tracked geo-coded information of the handheld unit, and the geo-coded information of the remote locations. The updated schedule may be transmitted to the handheld unit of the remote agent. The transmittance may be performed by the remote activity manager. The updated schedule may be displayed via the user interface for the handheld unit.

In an embodiment, geo-coded information of the handheld unit may be periodically tracked as the remote agent visits the target locations. Such visitations may be verified based on the tracked geo-coded information of the handheld unit. This verification may be performed by the remote activity manager. The schedule and the tracked geo-coded information of the handheld unit may be compared. Such a comparison may be performed by the remote activity manager.

A report of any variances between the schedule and the tracked geo-coded information of the handheld unit may be generated. The report may be generated by the remote activity manager.

A route may be generated based on the schedule. The route may provide directions to a target location. The route may be transmitted to the handheld unit of the remote agent. The route, remote location information and the schedule may be consolidated and transferred together. Such transmittances may be performed by the remote activity manager. The route may be displayed via the user interface for the handheld unit.

In an embodiment, the remote agent may be a marketer. The target locations may be various places where the marketer meets with various contacts to conduct business. The remote locations, and thus the target locations, may be healthcare provider locations.

The scheduling engine, according to an embodiment, may prioritize the target locations based on pre-determined business rules and contact parameters for the target locations. The schedule may be partially based on the prioritized target locations.

The generation of a schedule may comprise the establishment of an anchor point. Such an anchor point may be based geo-coded information of the handheld unit. The schedule may be optimized based on travel information, such as the travel time between the anchor point and the target locations. The basis may be the geographic proximity to the anchor point.

An updated schedule may also be generated through the establishment of an anchor point based on the geo-coded information of the handheld unit. The updated schedule may be optimized based on travel information. This may be based on a travel time between the anchor point and the target locations and/or a geographic proximity to the anchor point.

The anchor point may be established daily. In addition, the generation of a schedule may be automatically performed daily.

In an embodiment, the corresponding visit frequencies may be based on contact characteristics. These characteristics may include any combination of such characteristics, including referral patterns, specialties, key dates, and contact requests.

Visit frequencies may also be based solely on referral patterns. In an embodiment, a list of contacts may be obtained from a source of remote locations. The list of contacts may be based on a quantity of referrals. A top tier visit frequency may be assigned to contacts in a top tier of the list. The top tier visit frequency may also be assigned to contacts with a decrease in the quantity of referrals. The decrease may be determined by a referral trend over a given period of time. The top tier visit frequency may be assigned to new contacts on the list. The new contact assignment may continue for a limited period of time. The new contacts may be reassigned a visit frequency after the limited period of time based on the referral patterns. A second tier visit frequency may be assigned to contacts in a second tier of the list. Further, a third tier visit frequency may be assigned to contacts in a third tier of the list. The third tier visit frequency may also be assigned to non-referring contacts on the list. Such non-referring contacts may have zero referrals.

The top tier visit frequency contacts may be visited once per week, in an embodiment. In addition, the second tier visit frequency contacts may be visited twice per month. Finally, the third tier visit frequency contacts may be visited once per month.

In another embodiment, the top tier visit frequency contacts may be visited more often than the second tier visit frequency contacts. Further, the second tier visit frequency contacts may be visited more often than the third tier visit frequency contacts.

In an embodiment, contacts may be assigned a priority level based on a quantity of referrals for the corresponding contacts. The priority level may be selected from a set of priority levels. The set of priority levels may be based on the number of business days per year.

Visit frequencies may be based on specialties. In an embodiment, a list of contacts may be obtained from a source of remote locations. The list of contacts may be based on a contact specialty. A top priority tier visit frequency may be assigned to contacts having a top priority tier contact specialty. The top priority tier contact specialty may be based on a determination of potential business. A low tier visit frequency may be assigned to contacts having a low tier contact specialty. The low tier contact specialty may be based on the determination of potential business. The top priority tier visit frequency contacts may be visited once per week. The low tier visit frequency contacts may be visited once per month.

Visit frequencies may be based on key dates. In an embodiment, a special date may be assigned to contacts based on a date such as an anniversary date, a birthday date, or a special occasion date. The special date may be collected via the user interface. The remote agent may be scheduled to visit the contacts on the special date. A requested return visit date may be assigned to the contacts based on a return date. The return date may be a vacation date or an availability date. The return date may be collected via the user interface. The remote agent may be scheduled to visit the contacts on the return date.

Visit frequencies may be based on contact requests. In an embodiment, the contact requests may be assigned to the contacts based on a request such as an increase visit frequency request or a decrease visit frequency request. The contact requests may be collected via the user interface. The remote activity manager may also transmit the contact requests to a system administer for review.

The remote activity manager may receive contact parameters from a source of remote locations. The remote activity manager may also receive geo-coded information from a source of geo-coded information. Further, the remote activity manager may transmit contact parameters and geo-coded information to the scheduling engine. In addition, the remote activity manager may receive the schedule from the schedule engine.

Generation of the schedule may comprise assigning a contact status to the contacts and optimizing the schedule based on the contact status. The contact status may be a customer status or prospect status. In an embodiment, all of the contacts may be prospective clients. Alternatively, all of the contacts may be current clients.

In an embodiment, the contact parameters for the target locations may be determined based on contact characteristics such as business relationships. The relationships may be any of the following: a no prior business relationship; a new business relationship; a consistent business relationship; a increasing business relationship; a decreasing business relationship; a last business relationship; a loyal business relationship; a discount business relationship; a impulse business relationship; a wandering business relationship; a dissatisfied business relationship; an indecisive business relationship; a base business relationship; a satisfied business relationship; a referred business relationship; a contracted business relationship; a rare business relationship; and, a need-based business relationship.

In an embodiment of a system for directing the activities of remote agents, a remote activity manager may be adapted to generate target locations based on geo-coded information of remote locations. The target locations may be locations having contacts. The target locations may be a subset of the remote locations. A scheduling engine may be adapted to generate a schedule based on pre-determined business rules, contact parameters for the target locations, and the geo-coded information. A handheld unit may be adapted to receive the schedule. The remote activity manager may be further adapted to communicate with the handheld unit via a long range wireless network, and further adapted to transmit the schedule to the handheld unit. A user interface may be adapted to display the schedule on the handheld unit.

In an embodiment, the remote activity manager may be further adapted to receive the contact parameters from a source of remote locations. In addition, the remote activity manager may be further adapted to receive the geo-coded information from a source of geo-coded information. The remote activity manager may also be further adapted to transmit the contact parameters and the geo-coded information to the scheduling engine. The scheduling engine may be further adapted to transmit the schedule to the remote activity manager. The remote activity manager may be further adapted to receive remote location information from a source of remote locations. The remote activity manager may be further adapted to transmit remote location information to the handheld unit.

The handheld unit may be further adapted to track, at predetermined intervals, geo-coded information of the handheld unit. The handheld unit may also be further adapted to transmit the geo-coded information of the handheld unit to the remote activity manager. As such, the handheld unit may track the location of the handheld unit, thereby allowing the remote activity manager to verify the visit information.

In addition, the handheld unit may be further adapted to receive visit information. The handheld unit may also be further adapted to transmit the visit information to the remote activity manager. Hence, the schedule may be presented to the remote agent on the handheld unit, and the remote agent may provide visit information via the handheld unit.

In an embodiment, the system may be adapted such that the remote agents are marketers and the target locations are places to be visited by the marketers.

The remote activity manager may be further adapted to determine the contact parameters based on contact characteristics of the contacts. The contact parameters may include corresponding visit frequencies.

The scheduling engine may be further adapted to update the schedule based on pre-determined business rules, updated contact parameters, updated geo-coded information of the handheld unit, and the geo-coded information of the remote locations. The scheduling engine may be further adapted to transmit the updated schedule to the handheld unit of the remote agent. The handheld unit may be further adapted to display the updated schedule via the user interface.

The scheduling engine may be further adapted to generate a route based on the schedule. The route may provide directions to at least one of the target locations. The remote activity manager is further adapted to transmit the route to the handheld unit of the remote agent. The handheld unit is further adapted to display the route via the user interface.

According to an embodiment, the scheduling engine may be further adapted to establish an anchor point based on geo-coded information of the handheld unit of the remote agent. The scheduling engine may be further adapted to optimize the schedule based on travel information. This may be based on a travel time between the anchor point and the target locations or a geographic proximity to the anchor point.

The source of remote locations may be a billing system adapted to maintain information relating to referrals from contacts at the target locations. Contact parameters may include corresponding visit frequencies. The corresponding visit frequencies may be based on contact characteristics. The characteristics may include any of the following: referral patterns, specialties, key dates, or contact requests.

In an embodiment, a first and second computer-usable medium may have computer readable instructions stored thereon for execution by a processor. The instructions on the first medium may be adapted to execute on a system comprising a scheduling engine. These instructions may also be adapted to: provide target locations having contacts to the scheduling engine; provide geo-coded information of remote locations to the scheduling engine; generate, via the scheduling engine, a schedule based on pre-determined business rules, contact parameters for the target locations, and the geo-coded information; provide the schedule to a remote activity manager; provide the schedule and geo-coded information to a handheld unit; and, receive visit information and tracked geo-coded information of the handheld unit from the unit. The instructions on the second medium may be adapted to: execute on the handheld unit; receive the schedule and the geo-coded information; display the schedule and the geo-coded information via a user interface; receive visit information from the remote agent; track geo-coded information of the handheld unit at predetermined intervals; and, transmit visit information and tracked geo-coded information to the remote activity manager.

### BRIEF DESCRIPTION OF THE DRAWINGS

The foregoing and other objects, features, and advantages of the invention will be apparent from the following more particular description of embodiments as illustrated in the accompanying drawings, in which reference characters refer to the same parts throughout the various views. The drawings are not necessarily to scale, emphasis instead being placed upon illustrating principles of the invention.

FIG. 1 is a block diagram illustrating the components of an embodiment of the system of the present invention, and suitable for use in connection with embodiments of the method and storage medium of the present invention.

FIG. 2 is a block diagram illustrating data feeds from major components of an embodiment of the system of the present invention, and suitable for use in connection with embodiments of the method and storage medium of the present invention.

FIG. 3 is a flow chart of an example of a method for directing activities of a remote agent, in accordance with certain embodiments of the invention.

FIG. 4 shows an example of the steps for determining contact parameters and associating contact parameters with corresponding visit frequencies, in accordance with certain embodiments of the invention.

FIG. 5 shows an example of a corresponding visit frequency based on contact characteristics selected from the group consisting of referral patterns, specialties, key dates, and contact requests.

FIG. 6 is a flow chart illustrating certain importation and administrative processes in connection with which a preferred embodiment of the present invention may be utilized.

FIG. 7 is a flow chart illustrating certain daily processes in connection with which an embodiment of the present invention may be utilized.

FIG. 8 is a flow chart illustrating certain processes in connection with which marketers may utilize an embodiment of the present invention.

### DETAILED DESCRIPTION OF THE EMBODIMENTS

Reference will now be made in detail to the embodiments of the present invention, examples of which are illustrated in the accompanying drawings.

Described herein is a system and method for efficiently directing the activities of remote agents tasked with activities to be performed at target locations. An embodiment of the present system and method is adapted to direct the activities of healthcare marketers tasked with repeat visits to healthcare providers based on a recurring schedule. The system and method, however, need not be limited to the healthcare marketing industry and alternate embodiments are suited for use in a wide variety of applications in which remote agents are tasked with activities to be performed at remote locations, particularly in which the same locations are visited on a recurring schedule.

The presently disclosed invention provides an improved means of scheduling visits to remote locations based on business rules, contact information, and geo-coded information. A further object of the present invention includes distribution of proposed visitation schedules to remote agents through handheld devices with a user interface capable of both directing the activities of remote agents. The present invention also provides the benefit of tracking the actual activities of remote agents against proposed schedules in order to ensure the completion of tasks and goals. An additional advantage includes an efficient, incontestable verification of all visitations by the remote agents based on the tracked geo-coded information of the handheld units with location tracking capabilities. Further, the disclosed invention allows for feedback from the remote agents through handheld devices with a user interface capable of accepting input regarding the status of those activities. Such feedback provides the benefit of updated contact information for the remote locations, which may be used in the formation of future schedules.

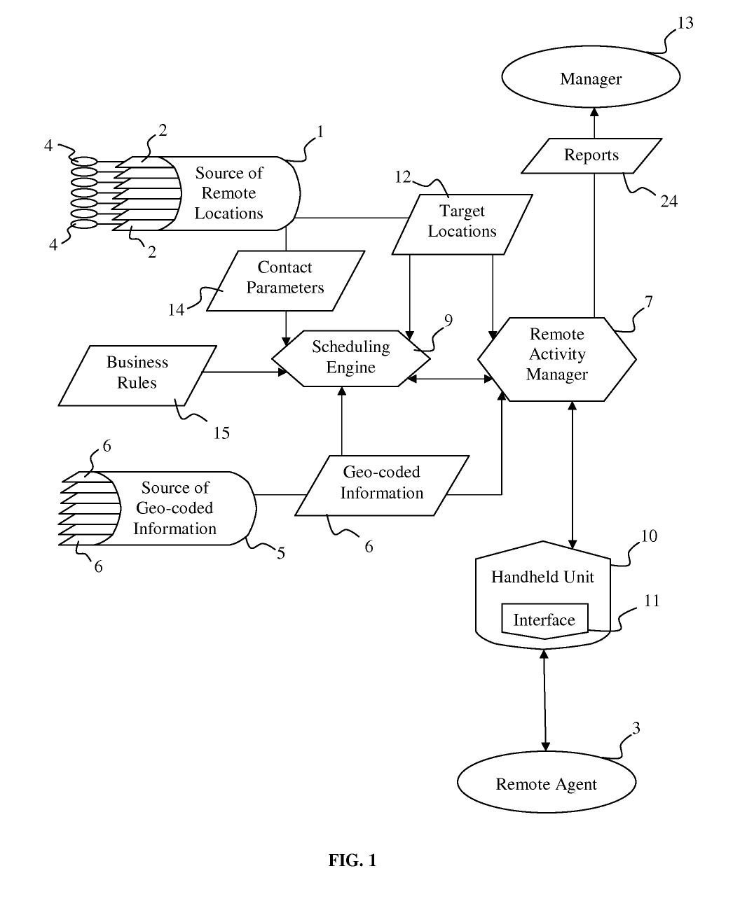

FIG. 1 illustrates a source 1 of remote location information 2. The remote locations source 1 may be a data source containing, or providing access to, a set of remote locations 2 eligible for visits by remote agents 3. The remote locations 2 may be an ordinary place of business for contacts 4. For example, a remote location 2 may be a clinic and the contacts 4 may be healthcare providers. In such cases, the remote location 2 may have a conference room or office where a remote agent 3, such as a marketer or sales person, may meet with a contact 4 to conduct business.

Examples of a remote locations source 1 may include a billing system such as that provided by AthenaHealth, which maintains information on actual customers or sources of referrals to customers, a store of contacts in a contact management or customer relationship management system such as GoldMine, Act or Seibel, a database of delivery addresses, or any other source of information containing at least an identifier for each individual location and an address or other indication of location. It will be understood that such a remote locations source 1 could be a server-based software system with an application programming interface or export capability, a web service, a database, or a flat file containing the relevant information.

FIG. 1 also illustrates a source 5 of geo-coded information 6 for remote locations 2. A geo-coded information source 5 may include a data source or service capable of translating the address or other indication of location into latitude and longitude or equivalent set of coordinates. A geo-coded information source 5 may also be capable of providing street directions or the equivalent from one set of coordinates to another, together with an estimate of the time required to travel between the coordinates. One example of a geo-coded information source 5 appropriate for use with an embodiment of the system of the present invention is the MapPoint system available from Microsoft. Other services and data sources such as Google Maps, web services, or similar systems may also serve as a geo-coded information source 5.

The presently disclosed invention comprises a remote activity manager 7 which may be capable of accepting location information from a remote locations source 1 and a proposed schedule 8 from a scheduling engine 9. Further, a remote activity manager 7 may be capable of consolidating such information and communicating it to handheld units 10 of remote agents 3. A handheld unit 10 may include a user interface 11.

The remote activity manager 7 may generate a list of target locations 12 (not shown), which may be a subset of remote locations 2. Such target locations 12 may be based on the location of a remote agent 3.

In an embodiment, the remote activity manager 7 may take the form of a customized version of a server-based customer relationship management system such as, but not limited to, GoldMine, in combination with an extension that allows the information in such system to be viewed on handheld devices 10 by remote agents 3. A further extension may include a reporting engine, such as Crystal Reports, capable of generating reports 24 from the data stored in the customer relationship management system suitable for the needs of management personnel 13 who are tasked with monitoring the activities of remote agents 3.

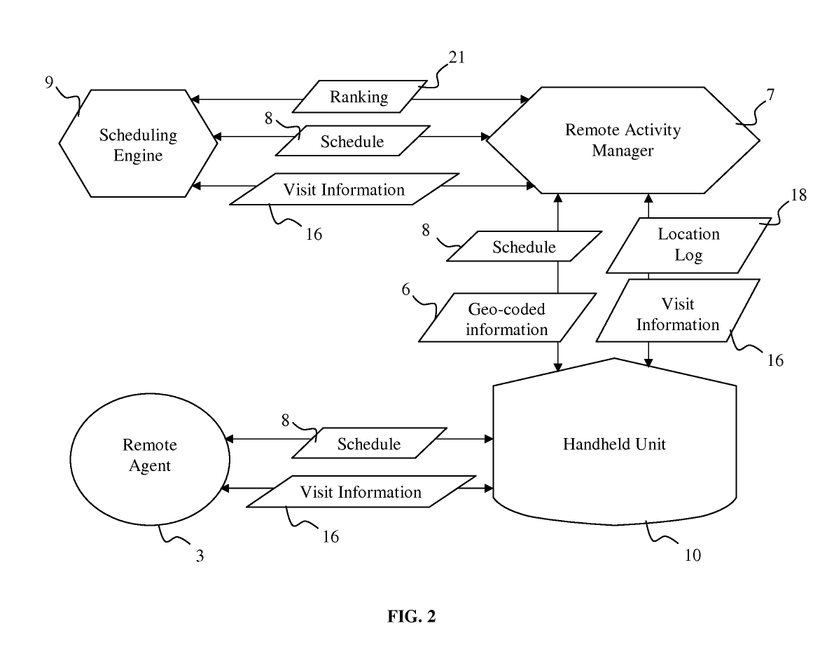

As shown in FIGS. 1 and 2, the scheduling engine 9 may be capable of: accepting information on target locations 12 and contact parameters 14 from a remote locations source 1, accepting geo-coded information 6 from a geo-coded information source 5, and/or applying predefined business rules 15 to generate proposed schedules 8. A scheduling engine 9 may conveniently be divided into two subsystems, one that may prioritize the potential target locations 12 based on contact parameters 14 and business rules 15, and another that may generate a preferably optimized schedule 8 that allows high priority target locations 12 to be visited in a reasonably efficient order. A wide variety of software systems can be used to implement a scheduling engine 9 including, without limitation, a spreadsheet program such as Microsoft Excel in which business rules are coded into formulas, a custom software program, class or library, or existing functions of a contact management or other business system. Such systems can be combined in various manners apparent to those of skill in the art to create a scheduling engine 9 suitable for use with embodiments of the present invention. In an embodiment, the activities of the scheduling engine 9 may be performed by the remote activity manager 7. The scheduling engine 9 and the remote activity manager 7 may be implemented by a single software system.

As further shown in FIG. 2, handheld units 10 may include any physical device capable of: receiving a proposed schedule 8 and geo-coded information 6 from a remote activity manager 7; accepting visit information 16 from a remote agent 3 and transmitting such visit information 16 back to the remote activity manager 7; monitoring actual physical locations 17 of the handheld unit 10 itself and transmitting a log 18 of such locations 17 over time back to the remote activity manager 7; and, adapted for use by a remote agent 3 such as a marketer, marketing representative, sales person or delivery person. Examples of handheld units 10 suitable for use with preferred embodiments of the present invention include Blackberry smart phones with GPS capability, Internet browsers installed for communications with a remote activity manager and a system such as Comet Tracker for tracking actual locations 17 over time and transmitting a log 18 of such locations 17.

Other possible examples of handheld units 10 suitable for use with embodiments of the present invention include, without limitation, Android smart phones with GPS, web browser and tracking capabilities, Apple iPhones with similar capabilities, Personal Data Appliances (“PDA”) with similar capabilities, and custom-designed handheld units. A tablet computer, netbook computer, or laptop computer could also serve as a handheld unit 10 in embodiments of the present invention provided that GPS or equivalent capabilities and appropriate communications and interface software is installed.

It will be further understood by those of skill in the art that while a web-based interface displayable in a web browser executing on a handheld unit 10 is one method of providing a suitable interface 11 for use by a remote agent 3, other interfaces 11 including custom client applications may also be used. The specific technology of the interface 11 being less significant than its ability to display proposed schedules 8 and geo-coded information 6 provided by a remote activity manager 7, and to accept and transmit back visit information 16, such as updated contact information, supplied by a remote agent 3.

It will be further understood that, while the use of a wireless data network 19 with connections to the Internet is one convenient means of enabling communication between handheld units 10 and remote activity managers 7, it is not the only such means. Dedicated wireless networks, tethering setups in which a handheld unit communicates with a computer that relays information, satellite networks, and even store and forward systems utilizing access points such as those available at Internet cafes or home networks could all be utilized to provide communications between handheld units 10 and remote activity managers 7 with alternative embodiments of the present invention.

A healthcare embodiment of the system of the present invention will now be described. It will be understood that the method of the present invention is also consequentially described in connection with the use of the system.

The presently described embodiment is adapted to suit the needs of a medical imaging provider in the business of providing x-rays, computed tomography, magnetic resonance or similar imaging services to patients referred by healthcare providers. Marketers or remote agents 3 are tasked with visiting healthcare providers or contacts 4 on a regular basis in order to encourage a continued stream of referrals and otherwise communicate with the provider 4 regarding available services.

In such an embodiment, a billing system such as that provided by AthenaHealth serves as one source 1 of remote locations 2. In that instance, the billing system contains information regarding the providers 4 that referred patients to centers run by the medical imaging provider as well as the addresses of the referring providers 4 and other information regarding the referring providers 4. Target locations 12 and contact parameters 14 (including referral histories) can thus be exported to a database or report containing the names and addresses of the referring providers 4 together with information regarding the number and frequency of referrals 20. This number and frequency of referral information 20 can either be consolidated directly in the billing system to create a ranking 21 among providers 4, or can be separately aggregated, for example by a spreadsheet program such as Microsoft Excel or a database program such as Microsoft Access.

A separate scheduling engine 9 can read and process the target locations 12 and contact parameters 14 according to business rules 15 in order to generate a ranking 21 of providers 4 who should be visited by marketers 3 acting as remote agents 3. A virtually infinite number of business rules 15 could be applied including, without limitation, a formula 22 based on the number of referrals from the provider 4 in the last 90 and 120 days, the relative number of referrals provided by a given provider 4 compared to his or her peer group, and the relative trend (increasing or decreasing) in the frequency and/or value of such referrals.

Such a formula 22 may be calculated by, for example and without limitation, a spreadsheet with formulas adapted to assign a frequency of visit to each provider 4, with stronger referral sources being visited more often than weaker referral sources. For example, strong referral sources (as determined by the parameters discussed above) according to the business rules may be scheduled for weekly visits, while weak referral sources might be scheduled for visits only monthly or quarterly.

To avoid overly burdensome travel requirements, providers 4 may be divided into regions sized to be served by a single remote agent 3, with the scheduling engine 9 being adapted to prioritize providers 4 within regions. Visit information 16, such as a communication from the provider 4 that he or she prefers to be visited no more than monthly, may also be taken into account in the business rules 15. The end result may conveniently be a ranking 21 of providers 4 to be visited, each with a priority and proposed visit frequency 23, generated based on the application of business rules 15 to the contact parameters 14 from the remote locations source 1.

The ranking 21 of providers 4 is made available to the remote activity manager 7, as shown in FIG. 2. In the case of the embodiment presently being described, the remote activity manager 7 is made up of a customer relationship management system, such as GoldMine, extended with web and reporting interfaces and custom software. The remote activity manager 7 receives geo-coded address information 6, and preferably driving directions, from the geo-coded information source 5, which in an embodiment may be Microsoft's MapPoint system. The customer relationship management system may track the history of visits to each referring provider 4, together with address and other information about the provider 4.

Custom fields can be used to store information such as a latitude and longitude provided for the address by the geo-coded information source 5. Because of potential variances in the mapping of addresses to coordinates such as latitude and longitude, it is preferred that multiple sources of geo-coded information 6 be used with either multiple results or an average or combined result being stored in the custom field.

The custom software may then combine the coordinate information, prioritization or ranking 21, visit frequency 23, and history of visits to generate a proposed schedule 8 for a marketer 3 on a given day. Directions from different points on the route may also be obtained from a geo-coded information source 5, together with projected travel times between remote locations 2. The resulting schedule 8 is then stored as a set of appointments in the database of the customer relationship management system.

As is understood by those of skill in the art, customer relationship management systems can be extended such that information relating to customers and scheduled appointments is delivered to handheld units 10 over the Internet 19, including, in some embodiments, creating entries in a calendar program running on the handheld unit 10. One such mechanism for doing so uses a web browser running on the handheld unit 10 in combination with a web or user interface 11 to the customer relationship management system. Given the small screen size and limited data entry capabilities of many handheld units 10, it is preferred that the web interface 11 be optimized for use on a small display. In this way, the remote marketer 3 can receive the proposed appointment schedule 8 directly on the handheld device 10 and utilize the interface 11 to the customer relationship management system to view information about each provider 4 and enter indications that the visit was completed and any notes regarding information 16 obtained during the visit. The interface 11 may then update the customer relationship management system with the records from the visit.

Because of the possibility that incorrect or false information may be entered by the remote agent 3, it is desirable for the handheld unit 10 to further comprise a real time location system such as a GPS receiver and software adapted to keep a log 18 of the location of the unit 10 during time intervals that correspond to the proposed schedule 8. Many available smart phones and similar handheld units 10 have GPS capabilities built in. All that is needed, therefore, is a software program adapted to read the information from the GPS, preferably at regular intervals, and transmit it back to the remote activity manager 7.

Comet Tracker is one such software system suitable for use with the embodiment presently being described. Configuring Comet Tracker to determine locations at a fixed interval, such as every five minutes from 8:00 am to 8:00 pm local time, and to transmit that information to the remote activity manager 7 at least daily, provides a verification feature that allows managers 13 to understand the determination of whether recorded visits are actually being made and if time of remote agents 3 is being efficiently utilized. In the event actual location information does not match a recorded visit, or the amount of time spent at the location 2 is less than a required minimum, the record of the visit can be rejected so that the visit may be rescheduled the following day. In this way, visit information 16 about recorded visits may be fed back into the schedule engine 9 or schedule generation function in order to further optimize proposed schedules 8.

A reporting engine such as Crystal Reports may be used to generate management reports 24 based on the information thus accumulated in the remote activity manager 7. Reports 24 including accuracy histories of remote marketers 3, reports 24 showing the communication histories with referring providers 4, and relative efficiency of remote agents 3 may be generated and then viewed by management personnel 13 responsible for oversight of the remote agents 3.

The embodiment previously described may be further enhanced by adding one or more sources 1 of prospective remote locations or prospects 2 to the target locations 12 considered by the scheduling engine 9. Sources 1 of prospects 2 could include databases of providers 4 who have not previously referred patients (and hence do not appear in the billing system), which lists are available from many sources 1. It is desirable for the scheduling engine 9 to be adapted to include prospects 2 in the proposed visitation schedule 8 in order to grow the pool of referring providers 4 in addition to increasing the frequency with which existing providers 4 refer patients. In such cases, either a unique identifier for each provider 4, such as the one provided by the Medicare system or other external databases, can be used to help avoid redundant scheduling entries in the event an existing referring provider 4 also appears in a list of prospects 2. In such an embodiment, the business rules 15 utilized by the scheduling engine 9 would be enhanced to account for prospects 2 when generating proposed schedules 8 and resolve any duplicates that may appear in the prospect list.

Screen displays for the user interface 11 of handheld units 10 may be adapted for display on a smart phone with web browsing and GPS receiver. The screen displays on such a smart phone may be adapted to display a proposed schedule 8 to a marketing agent 3, display additional information about target locations 12 to that agent 3, and accept information 16 pertaining to the agent's visits to those locations 12. The screen displays are provided through a web browser executing on the smart phone adapted to communicate with a web server provided by, or adapted to communicate with, a remote activity manager 7.

It will be understood by those of ordinary skill in the art that such screen displays and use of a web browser on the handheld units 10 are exemplary only and that the present invention is not limited to specific displays or communications through a web browser and its associated communication protocols, as many alternative arrangements may be used to accomplish equivalent results.

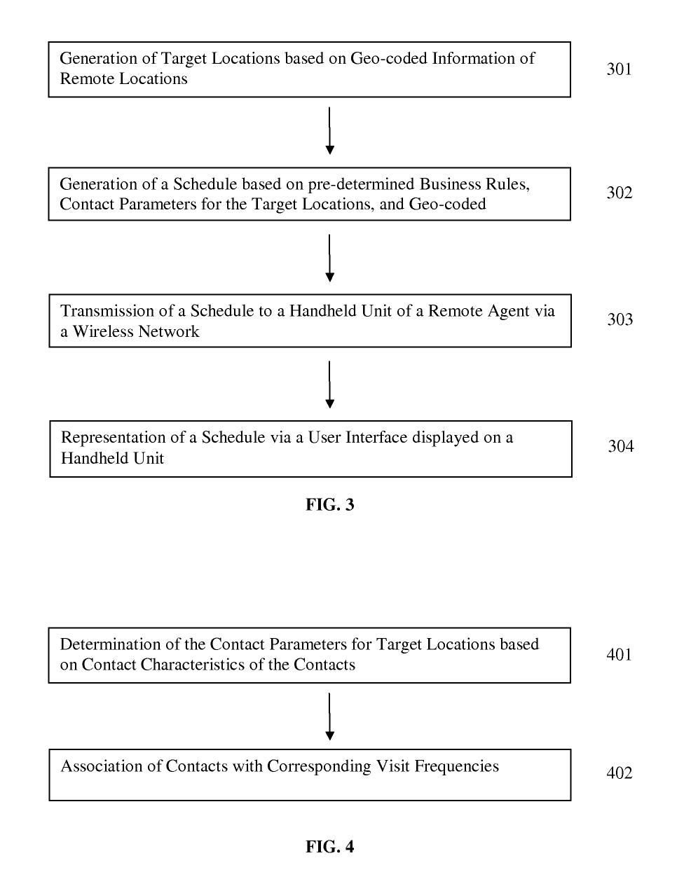

As shown in the embodiment depicted in FIG. 3, a method for directing activities of a remote agent may comprise the generation 301 of target locations 12 based on geo-coded information 6 of remote locations 2. The target locations 12 may be locations having contacts 4, as the target locations 12 may be a subset of the remote locations 2. Such generation 301 may be performed by the remote activity manager 7. Further, the method may comprise the generation 302 of a schedule 8 based on pre-determined business rules 15, contact parameters 14 for the target locations 12, and geo-coded information 6. Such generation 302 may also be performed by the remote activity manager 7. The schedule 8 may be transmitted 303 to a handheld unit 10 of the remote agent 3. The handheld unit 10 may be a programmable device. Such a device 10 may comprise a GPS receiver. The schedule 8 may be transmitted 303 by the remote activity manager 7, which may communicate with the handheld unit 10 via a wireless network 19. The wireless network 19 may be a long range network 19. In addition, the method may comprise displaying 304 the schedule 8 via a user interface 11 displayed on the handheld unit 10.

In an embodiment, the method may further comprise a determination 401 of the contact parameters 14 for the target locations 12 based on contact characteristics 25 of the contacts 4, as shown in FIG. 4. Contact characteristics 25 may comprise referral patterns 26, specialties 27, key dates 28, or contact requests 29.

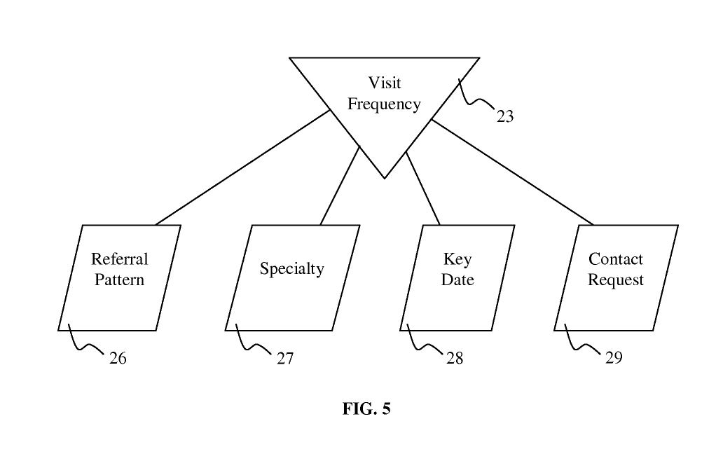

The contact parameters 14 may include corresponding visit frequencies 23. Certain combinations of contact characteristics 25 may be utilized in certain embodiments in order to assign or associate 402 visit frequencies 23 to contacts 4. As shown in FIG. 5, the determination of the corresponding visit frequencies 23 may be based on any number of contact characteristics 25 including, but not limited to, referral patterns 26, specialties 27, key dates 28, or contact requests 29. Certain contact characteristics 25 may have a higher priority or weight compared to other contact characteristics 25 in an embodiment.

Different methods may be used to assign a visit frequency 23 to a contact 4. In an embodiment where the assignment of a frequency 23 is based on a referral pattern 26, a list of every referring physician 4 may be pulled from a database 1 such as Athena's database. Contacts 4 in a top tier of referrals may be assigned a top priority frequency, such as a “once per week” frequency designation. For example, the top ten referring physicians 4, measured by quantity of referrals, may be assigned a “once per week” frequency.

Contacts 4 that have dropped in referrals may be assigned a top priority frequency, such as “once per week.” Any contact 4 with a drop in referrals may be assigned a top tier frequency determined by a drop in referral trend over a given period of time.

Contacts 4 that have become new referring physicians may be given a top priority frequency, such as “once per week.” Once a prospect 4 becomes a customer 4 they may be assigned a top tier frequency for a given time, such as six weeks. Once an expiration date is reached, the customer 4 is reassigned a frequency based on referral patterns 26.

In an embodiment, contacts 4 in the second tier of referrals may be assigned a second tier frequency, such as a “twice per month” frequency designation. The physicians 4 ranked 11-20, determined by quantity of referrals, may be assigned a frequency of “twice per month.” Contacts 4 in the last tier of referrals may be assigned a low priority frequency, such as a “once per month” frequency designation. All physicians 4 ranked 21 or lower, determined by quantity of referrals, may be assigned a frequency of “once per month.” Various different ranking thresholds may be utilized to assign frequency designations.

Contacts 4 that are non-referring physicians, such as prospects, may be assigned a low priority frequency, such as “once per month.” All non-referring physicians, determined by lack of referrals over a given time, may be assigned a frequency of “once per month.”

In an embodiment where the assignment of a visit frequency 23 is based on a specialty 27, a list of every referring physician 4 may be pulled from a database 1 such as one by Athena or NPI. A target specialty 27 may be determined, such as chiropractor, podiatrist, etc. Contacts 4 with a targeted specialty 27, determined by a potential for business with regard to the particular specialty, may be assigned a top priority frequency, such as a “once per week” designation. Other specialties 27 may be designated as lower priority, determined by potential for business from specialty, may be assigned a low priority frequency, such as “once per month.”

In an embodiment, a visit frequency 23 may be based on a key date 28. A key date 28 may be any special date for a contact 4, such as an anniversary, a birthday, etc. An end user, such as a remote agent 3, may enter the contact's special date into a KEY DATE field. An end user may be scheduled to visit the contact 4 on the given date. Appointments may be incorporated in a route. A key date 28 may be any requested return visit, such as a “return from vacation” date, an “only date available” date, etc. An end user may enter a requested return date into a KEY DATE field. The end user, such as a remote agent 3, may be scheduled to visit the contact 4 on the given date. Appointment may be incorporated into the remote agent's route.

In an embodiment, a visit frequency 23 may be based on an end user input or contact request 29, such as a request for a frequency change. End user or contact requests 29 may request a change because the visits are too often. For example, if the contact 4 does not want to be seen as much, the end user may enter a frequency drop request in the NOTES field while completing appointment. A request may be made because the visits are not enough. For example, if the contact 4 wants to be seen more often, the end user may enter a frequency increase request in the NOTES field while completing the appointment. Requests may be reviewed by a system administer. In addition, requests may be rejected or changed based on the circumstances.

The systems and methods for embodiments of the presently disclosed invention may comprise a determination of potential priority levels for contacts 4 based on a business relationship 30 with contacts 4. The relationships types may include, but not limited to, the following relationships 30: no prior relationship, new business relationship, consistent business relationship, increasing business relationship, decreasing business relationship, lost business relationship, loyal business relationship, discount business relationship, impulse business relationship, wandering business relationship, dissatisfied business relationship, indecisive business relationship, base business relationship, satisfied business relationship, referred business relationship, contracted business relationship, rare business relationship, and need-based business relationship. The relationships 30 may be prioritized.

An embodiment of a system according to the present invention and suitable for use with the methods of the present invention is referred to herein as a HIT system. Such a system may have a sales automation and territory management application suite designed to streamline marketing calls through automatic appointment scheduling and routing, enforce corporate business rules 15, and enable rapid territorial deployment and realignment.

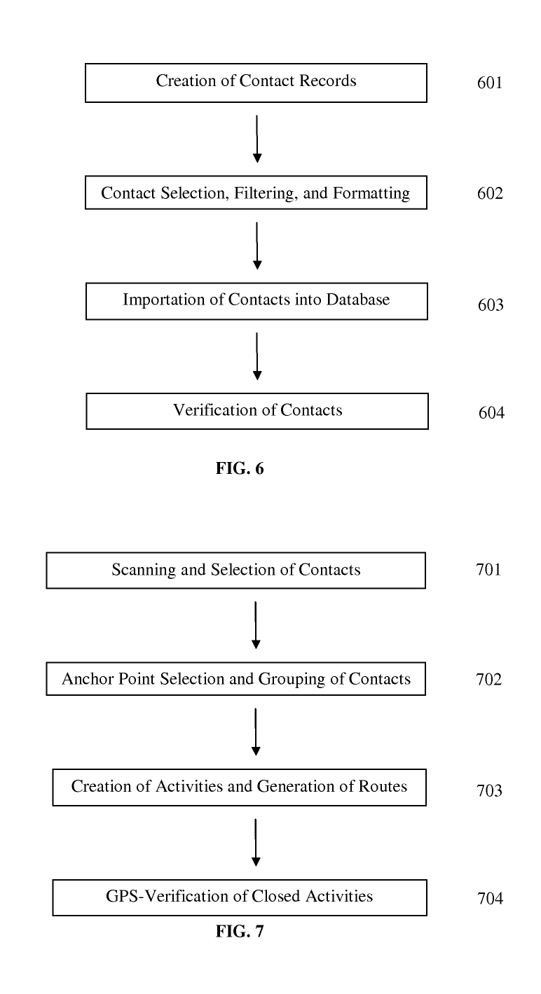

In such an embodiment, the workflow of a system according to the present invention may conveniently proceed as described herein. An administrative setup procedure is illustrated in FIG. 6. The process may begin with the creation 601 of records for contacts 4 (such as Service Center and Marketing Rep contact records in an embodiment) in a remote locations source 1 such as Goldmine. The number of appointments per day may be assigned to the Service Center contact record, and the street address of the marketer or facility is entered as the address for the Marketing Rep contact record (start point for routing). A market name may be assigned to the territory, i.e. STAUGUST for Saint Augustine, Fla., and this value is used to create the Goldmine and wMobile user accounts. The market name may also be set in the Marketing Rep and Service center fields of the Service Center and Marketing Rep contact records.

The contacts 4 may subsequently be selected, filtered, and importation formatted 602, as depicted in the second step of FIG. 6. A contact importation or retrieval procedure may comprise contact selection 602. An administrator or marketing manager 13 may select a group of contacts 4 from a source 1, and filter 602 the contacts 4 for geographic area, practice specialization, taxonomy code, etc. Optionally, the marketer 3 or marketing manager 13 may review the list prior to importation to eliminate duplicates, reassign territories, etc. In an embodiment, the list of contacts 4 to be loaded may contain: Company or Contact name (first, last name); Physical street address (which may be necessary for routing); and, Contact Title, Phone/Fax/Email, Specialty, etc (which may be optional in some embodiments).

Assigned values required during import may include an UAPPTFREQ value, which is an Appointment Frequency relating to how often a contact 4 should be visited (typically once a month, twice a month, or once a week). Also, a Marketing Rep and Service Center value, which may assign that record to a particular territory/marketer. In addition, a Contact Type value may designate whether the contact 4 is a prospect or a customer. Further, a NPINUMBER value may be included, which is a unique numerical value used to prevent future duplicate contacts.

A contact importation or retrieval procedure may further include Import Formatting 602, which may comprise a typical import into an embodiment of the disclosed system, such as a HIT system, which may be from a properly formatted and cleaned .CSV file. A .CSV file may be cleared of any data that could corrupt the import process, such as commas.

A contact importation or retrieval procedure may also include contacts 4 imported 603 using Goldmine's Import/Export wizard, and verified 604 afterwards. As the contacts 4 are imported, the disclosed system may uses MapPoint to geo-code the street address into a LAT/LONG value and assigns it to the contact 4. Addresses that cannot be resolved due to misspelling, etc, are marked as NON-GEOCODED, which may require manual correction.

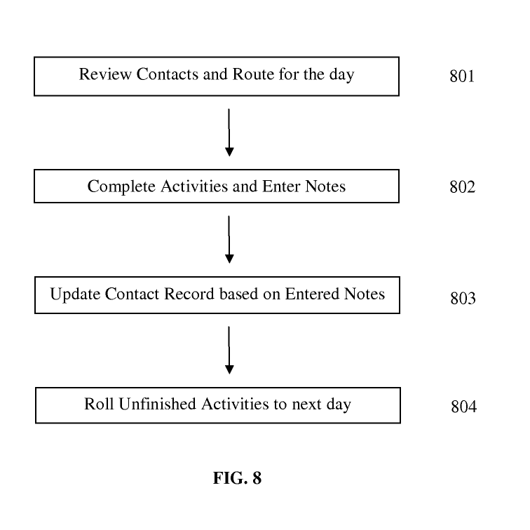

Once administration and importation are complete, an automated daily process can be initiated, as shown in FIG. 7. The system database may be scanned 701 to determine which contacts 4 are due for a visit. Contacts 4 due for a visit within three additional business days are considered in the pool to improve routing efficiency. For each market, a contact 4 is selected 702 as the anchor point 31 for that day and the pool of contacts 4 is grouped 702 according to geographic proximity to the anchor point 31. Pending activities are created 703 for the appropriate number of contacts 4 for the day in each market. A list is exported to MapPoint for routing, and driving directions are added to each pending activity's notes. Prior day's closed activities are scanned to verify 704 GPS stop points.

In an embodiment, support procedures for markets 3 and the disclosed system can then be performed according to FIG. 8. Before proceeding on the route, a marketer 3 may login to a system, such as a HIT system, via a laptop or mobile device such as a handheld unit 10, and review 801 the marketer's route for the day. As each visit is concluded, a marketer 3 may close a pending activity and enter notes 802 with the following information: relevant information regarding the visit; result codes such as COM for “completed”, NOC for “not completed”, etc.; corrections to the contact record; and, requests to change the status of the contact 4, such as idling, reassigning, reprioritizing, or deleting the contact. The entered notes may be reviewed and necessary changes updated 803. In an embodiment, marketers 3 may not have the ability to alter contact record information. At the completion of the day, any unfinished pending activities may automatically be rolled into the next day 804.

To ensure acceptable performance, a number of considerations may be addressed. Hardware may have sufficient capacity to complete daily automated processes in less than thirty minutes. Internet connectivity may be an important performance consideration in certain preferred embodiments. In an embodiment of a system such as a HIT system, where users utilize the wMobile web interface, and support and administrators utilize iGoldmine or a Remote Desktop Protocol (RDP) client, the system may be entirely thin-client based. Therefore no large amounts of data need be transmitted into or outside of the corporate network. Mass importing and other administrative tasks are done inside the corporate network. Therefore even modest Internet/Intranet performance connectivity is sufficient for access using a thin client sufficient for such embodiments. In embodiments utilizing clients that transmit or receive larger quantities of data, additional bandwidth may be desirable.

Software components that may be appropriate for use in an embodiment of the present invention may comprise: a network operating system, such as Windows server 2003 R2 standard SP2; a web server hosting platform, such as IIS 6.0; an application programming frameworks, such as .NET 2.0 and 3.5; a contact management application, such as Goldmine 9.0; an application for web-based remote connectivity to a Goldmine client, such as iGoldmine 8.0; a database storage platform, such as SQL Server 2008; a web client interface component for the system, such as wMobile; an application for gathering and reporting GPS coordinates from mobile devices, such as CometTracker; an interface application for MapPoint 2010, such as Mapview; and, a mapping and routing application, such as MapPoint 2010.

Suitable hardware for an embodiment of the present invention may comprise a server, such as a HIT server in an embodiment for a HIT system, and a Comet Tracker server. The HIT server may comprise OS—Windows Server 2003 R2 Standard SP2 4; CPU/RAM—Intel Xeon E5530 2 GHz quad-core w/ HT, 4 gb RAM; Storage—RAIDS array, 600 gb; and, primary applications that may be installed, such as IIS 6.0, .NET 2.0 and 3.5, Goldmine 9.0, Goldmine 8.0, Microsoft SQL Server 2008, wMobile, MapView, and MapPoint 2010. The Comet Tracker Server may comprise OS—Windows XP Professional SP3; CPU/RAM—Intel Core2 Duo E7400 2.8 GHz, 3 GB RAM; Storage—2×250 GB hard drives, volumes; and primary applications, such as Comet Tracker.

In an embodiment, the system may include a Microsoft SQL database, which may be structured as described herein. Primary Goldmine tables may include CONTACT1, which may comprise primary contact information such as name information, such as company, contact name, salutation (e.g. dear), or last name; address information, such as address1, address2, city, state, or zip; and electronic contact information, such as e-mail, phone1, or fax. The CONTACT1 table may also include key fields, such as Key1 for contact type, Key2 for service center, Key3 for marketing representative, Key4 for category, Key5 for NPI number, and a remote locations source 1.

Primary Goldmine tables may further include CONTACT2, which may comprise of the following fields UREFTYPE for referral type, USPECIALTY for specialty 27, UPREFS for preferences, USPECLTRT for special treatment, UGEOSTATUS for geo-code status, UGEOLAT for latitude, UGEOLONG for longitude, UGPSKEY for GPS key, UAPPTFREQ for appointment frequency, UAPPTDTN for the number of days until the next appointment, UDTLSTREF for the date of the last referral, REFPERMTH for the number of referrals per month, and fields for certain days not to schedule appointments (such as UDAYMON for Monday, UDAYTUES for Tuesday, UDAYWED for Wednesday, UDAYTHURS for Thursday, and UDAYFRI Friday).

In addition, primary Goldmine tables may include CONTSUPP, which may comprise: additional contacts; e-mail addresses; website addresses; linked document information; scheduling parameters; holidays (such as days not to schedule appointments for any contacts, and days not to schedule appointments for specific contacts); and, key date (such as dates to schedule appointments for specific contacts). Primary Goldmine tables may further include: CAL (scheduled but uncompleted activities including: appointments, calls, and e-mails); CONTHIST (completed activities including: appointments, calls, and e-mails); and, LOOKUP (such as a pick list of choices for all fields).

In an embodiment, custom tables may comprise constant system tables. Such tables may include WSYS_GoldMineTables and WSYS_ROUTES_THRESHOLDS. WSYS_GoldMineTables may match GM table name with symbol for table. WSYS_ROUTES_THRESHOLDS may contain variables for RestTime, Distance, ExpandDays and RowID fields. RestTime is a minimum value in GPS Data RestTime to be considered an appointment. Distance is a maximum distance between GPS Rest Point and GoldMine Contact to be considered a match. ExpandDays is the number of days for appointments (including current day) to pool when grouping appointments by day and calculating route. RowID is a unique ID.

The custom tables may also comprise temporary tables. A table, such as ORION_GPS_DATA_TEMP, may contain data from previous days stop points in Tracker. Only stop points within RestTime Threshold variable are included. A table, such as WSYS_AnchorARCHIVE, may comprise anchor appointment for each Service Center and designated appointments for length of ExpandDays. A table, such as WSYS_ROUTES, may include routing data. A table, such as WSYS_ROUTES_HISTORY, may comprise data from previous days completed appointments in GoldMine. A table, such as WSYS_ROUTES_PROCESSING, may also be included. Further, a table, such as WSYS_VEHICLE_DATA, may include data from a GPS_Data view for previous day.

In an embodiment, Microsoft SQL jobs may comprise Orion_Schedule_Appts and Orion_GPS_Batch_Processing. Orion_Schedule_Appts may include several steps in an embodiment. In step 1, EXEC WP_Orion_Calculate_Days_To_Visit calculates days until next visit (appointment) for each prospect and customer. In step 2, EXEC WP_Master_Processor_Visits_Routes determines daily appointments for each Marketing Rep and optimizes each route using MapPoint logic. The following steps may be incorporated into step 2, or may be treated as distinct steps. In step 3, EXEC WP_Orion_Schedule_Visits may schedule appointments (Cal record) for contacts that are due. This may include contacts with “Key Date” designation, but may exclude contacts based on “Holiday” or “Days of Week” designation. In step 4, EXEC WP_Refresh_WSYS_Routes_Table may update WSYS_Routes Table with data in GPS_Data view from previous day. In step 5, EXEC WP_Route_Ordering may run the ORSLauncher.exe, which may comprise: a. calculate turn-by-turn route based on MapPoint logic; and b. write results back to WSYS_Routes Table. This may include the turn-by-turn directions that are later inserted into Appt Notes. In step 6, EXEC WP_Write_Back_Route_Ordering_To_Appts may update appointment created in Step 3 with data calculated in Steps 4 & 5.

Orion_GPS_Batch_Processing may also comprise of several steps. In step 1, EXEC WP_Refresh_WSYS_Routes_History_Table may refresh WSYS_Routes_History Table with GM Completed Appointments from previous day. In step 2, EXEC WP_Refresh_WSYS_Vehicle_Data_Table may refresh WSYS_Vehicle_Data Table with previous day's data from GPS_Data view. In step 3, EXEC WP_MATCHMAKER may update WSYS_MatchStatus field in WSYS_Vehicle_Data Table. This may include: Pass 1—Update records that have matching GM completed appointment with “MatchRouteClose”; Pass 2-Update records that have no matching GM completed appointment but have GM contact within distance Threshold with “MatchContactClosest”; and, Pass 3—Update remaining GPS_Data records with “NoMatch”. In step 4, EXEC WP_Write_GPS_Pass12_History_Records may: a) update GM completed appointment's with GPS data for “MatchRouteClose” (Step 3, Pass 1) records; and, b) create new GM completed appointment's with GPS data for “MatchContactClosest” (Step 3, Pass 2) records. In step 5, EXEC WP_Write_GPS_Pass3_History_Records may create new GM completed appointment on appropriate Marketing Rep contact record with GPS Data for “NoMatch” (Step 3, Pass 3) records.

In an embodiment, a Microsoft SQL database for the system may be augmented with business rules. Contact record selection and assignment may include selecting Customer Lists. This may comprise a source, such as Billing System by Athena. A filtering protocol may be used, which may be within a maximum radius (e.g., currently 25 miles) and may have submitted business within time threshold (e.g. 4 months). Selecting customer lists may further comprise selecting Prospect Lists, a source may be a NPI database or other (purchased list, manually gathered, etc.). Filtering protocol may be used, which may be within maximum radius, based on zip code (variable based on market), and may be based on Taxonomy codes. Determining appointment frequency may be performed for customers, such as top 20=52 (once per week), for all others=26 (once every other week); for prospects, such as all=12 (once per month). Contact maintenance may further include the following fields: prospect to active; prospect expiration and idling; changes in appointment frequency; alarms based on referral activity trends; and, customers versus prospect load outs.

The same embodiment may also include administrative procedures. Creating Marketing Rep and Service Center records may include: filling out address fields for both records, assigning Service Center and Marketing Rep (KEY2, KEY3), assigning appointments per day (USCAPPTDAY), and, assigning GPSKEY value from CometTracker. Creating GM user accounts may comprise a clone existing user and set permissions. Administrative procedures may further include the creation of wMobile accounts. Contact list importation may comprise formatting for import, which may include: elimination of commas values; elimination of many-to-one entries (multiple clients, same address), creation of CONTACT field (CONCANTENATES ‘DEAR’ and ‘LASTNAME’ fields), conversion of taxonomy code to string; assignment of NPI field (KEYS, if applicable), and conversion to .csv file. Contact list importation may further comprise assigning customer or prospect status (KEY1), assigning Service Center and Marketing Rep (KEY2, KEY3), assigning appointment frequency (UAPPTFREQ), assigning contact specialty 27 (USPECIALTY), importing to Goldmine and verification (Import/Export Wizard and Verification via Search Center), and resolving non-Geo-Coded addresses.

These administrative procedures may also include ongoing contact maintenance, which may further include idling contacts (setting UAPPTFREQ to 0) and combining contacts. In addition, a marketer's notes analysis may be included, which may comprise correcting contact record data, deleting and combining contacts, idling contacts, assigning key dates and holidays, and territory reassignment. Furthermore, administrative procedures may include backfilling NPINUMBER values (where applicable) and appointment maintenance for scheduled activities, such as deletion and rolling over and auto-updates for managing large numbers of scheduled activities.

The sample source code disclosed in U.S. Provisional Patent Application No. 61/494,076 is incorporated herein by reference. That source code is representative of certain steps and procedures which are described herein, and is intended to serve as a further description of the system of the present invention.

In an embodiment of the disclosed system, such as a HIT system, validation information may be removed from the Notes area. The marketing agents 3 may be allowed, on demand, to reprioritize their route for the day. Objectives may include providing more routing flexibility to marketing agents 3 and improve the way appointments are validated.

A user may be allowed to recalculate a route at any time, in an embodiment. A number of existing appointments to schedule for remainder of day may be recalculated, such as read appointments per day (Contact2.USCAPPTDAY) from a Service Center contact record, determine how many system generated appointments have been completed thus far, and schedule sufficient appointments to meet the appointments per day setting.

Further, a route may be recalculated from a marketing representative's current location based on GPS data, according to an embodiment. A system, such as a HIT system, may ensure that GPS data is delivered live by Comet Tracker to a Microsoft SQL view contained in the GoldMine main database. The GPS data provided by a view may comprise: a marketing representative's unique GPS Key, such as UserID; a date or time of record, such as Timetag; latitude data, such as Latitude; longitude data, such Longitude; and a stop time, such as StopTime. GPS data records may be related to GoldMine activities by storing both the marketing representative's GoldMine username and unique GPS data key on the marketing representative's contact record. The unique GPS Key may be a Contact2.UGPSKEY field, and the GoldMine username may be a Contact1.KEY3 field.

In an embodiment, a marketing representative 3 may have various options to recalculate a current day route. Appointments and the route may be recalculated based on the current location of the marketing representative 3. This may utilize a default criteria or the closest contact 4 to the current location based on GPS data for the marketing representative 3 as an anchor point 31.

Appointments and the route may be recalculated and limited to only customers 4. This may be based on a default anchor point 31. A default criteria (such as Contact1.KEY1=“Customer”) may be used with a filter such that only Customers are included, and a default anchor point 31 may be utilized. The current location may be utilized as an anchor point 31. A default criteria (such as Contact1.KEY1=“Customer”) may be used with a filter such that only customers are included, and the closest contact 4 to the current location of the remote agent 3 may be utilized based on GPS data for the remote agent 3 as the anchor point 31.

Appointments and the route may be recalculated and limited to only prospects 4, in an embodiment. This may be based on a default anchor point 31. A default criteria (such as Contact1.KEY1=“Prospect”) may be used with a filter such that only prospects are included, and a default anchor point 31 may be utilized. The current location may be utilized as an anchor point 31. A default criteria (such as Contact1.KEY1=“Prospects”) may be used with a filter such that only prospects are included, and the closest contact 4 to the current location of the remote agent 3 may be utilized based on GPS data for the remote agent 3 as the anchor point 31.

In an embodiment, wMobile enhancements may be utilized. A home menu item entitled “ReRoute” may be used. Also, a submenu items to ReRoute may comprise the following re-routing items: re-routing based on current location; re-routing to customers only; re-routing to customers only from current location; re-routing to prospects only; and re-routing to prospects only from current location.

In an embodiment, GPS validation may be changed to update appointment result code. GPS validation data may no longer need to be written to a notes section of an appointment. GPS data may be delivered live by Comet Tracker to Microsoft SQL view contained in GoldMine main database. The GPS data provided by a view may comprise a marketing representative's unique GPS Key, such as UserID; a date or time of record, such as Timetag; latitude data, such as Latitude; longitude data, such Longitude; and, a stop time, such as StopTime. GPS data records may be related to GoldMine activities by storing both the marketing representative's GoldMine username and unique GPS data key on the marketing representative's contact record. The unique GPS Key may be a Contact2.UGPSKEY field, and the GoldMine username may be a Contact1.KEY3 field.

GPS data validation may be processed once per night, according to an embodiment. Records with a “Rest Time” value below a predefined number of minutes may be ignored.

Remaining GPS data records may be compared to each remote agent's completed appointments for that same day. GPS data records may be within a predefined distance of appointment completed by a remote agent 3. If more than one completed appointment is within the defined distance, the closest completed appointment may be considered a match. If more than one GPS data record is within the defined distance of a matching appointment, the total combined stop times may be inserted into the appointment. When multiple GPS data records are within the defined distance of multiple completed appointments, there may be mismatches. GPS data may be inserted into a matching, completed appointment. Duration may have a value in Rest Time rows. Units may also have a value in Rest time rows. Result code may have a first character updated, such as to a “V” character.

GPS data records may be outside a predefined distance of a completed appointment but within a predefined distance of other GoldMine contact records. In such as case, according to an embodiment, a new completed appointment in GoldMine may be created. This may be attached to the closest contact record within a predefined distance. Values in a completed appointment may include the following values username may contain the remote agent's username, on-date may equal the value in date row, reference may contain “GPS Stop Point on Alternate Contact”, duration may contain a value in Rest Time rows, units may contain a value in Rest Time rows, and result code may contain a “VAL” value.

GPS data records may be outside a predefined distance of any GoldMine contact record. In such as case, according to an embodiment, a new completed appointment in GoldMine may be created. The completed appointment may be attached to a marketing representative's contact record. Values in a completed appointment may include the following values: username may contain the remote agent's username, on-date may equal the value in date row, reference may contain “Unmatched GPS Stop Point”, duration may contain a value in Rest Time rows, units may contain a value in Rest Time rows, and result code may contain a “VAL” value.

In an embodiment, a timeframe for routing reprioritization may be stored in a configurable threshold value. For example, such a value may be stored in a column entitled “Expand Days” within a table entitled “WSYS-ROUTES-THRESHOLDS” having the following valid values: 1, 2, 3, 4, 5, 6, or 7. Appointments within a specified ExpandDays threshold may be collectively evaluated. An algorithm may be used to determine the first appointment of day one. The first appointment may be the anchor point 31. The remaining appointments for that day may be taken from an ExpandDays group. The number of appointments for that day may be determined by a value on the Service Center record. Appointments in the ExpandDays grouping with the closest latitude and longitude coordinates to the anchor point 31 may be scheduled. Appointments may be routed using a Map Point Engine.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof. The term “adapted” when used in this application shall mean programmed, configured, dimensioned, oriented and arranged as appropriate to the purpose or function described.

While the invention has been particularly shown and described with reference to an embodiment thereof, it will be understood by those skilled in the art that various changes in form and details may be made therein without departing from the spirit and scope of the invention.

What is claimed is:

1. A method for directing activities of a remote agent, comprising the steps of:
generating, via a remote activity manager, target locations based on geo-coded information of remote locations, wherein the target locations are locations having contacts, wherein the target locations are a subset of the remote locations;
generating, via a scheduling engine, a schedule based on pre-determined business rules, contact parameters for the target locations, and the geo-coded information, wherein the contact parameters are based on contact characteristics of the contacts;
transmitting the schedule to a handheld unit of the remote agent, wherein the handheld unit is a programmable device comprising a GPS receiver, wherein the schedule is transmitted by the remote activity manager, wherein the remote activity manager communicates with the handheld unit via a long range wireless network; and,
displaying the schedule via a user interface for the handheld unit.

2. A method of claim 1, further comprising the step of:
determining the contact parameters for the target locations based on contact characteristics of the contacts, wherein the contact parameters include corresponding visit frequencies.

3. A method of claim 1, further comprising the steps of:
tracking geo-coded information of the handheld unit of the remote agent as the remote agent visits the target locations;
collecting updated contact information for visited locations, wherein the visited locations are a subset of the target locations, wherein the updated contact information is collected via the user interface of the handheld unit;
transmitting the updated contact information and the tracked geo-coded information to the remote activity manager; and,
updating the contact parameters for the visited locations based on the updated contact information, wherein the updated contact parameters include updated visit frequencies for the visited locations.

4. A method of claim 3, further comprising the steps of:
updating, via the scheduling engine, the schedule based on pre-determined business rules, the updated contact parameters for the visited locations, the updated tracked geo-coded information of the handheld unit, and the geo-coded information of the remote locations; and,
transmitting the updated schedule to the handheld unit of the remote agent, wherein the updated schedule is transmitted by the remote activity manager; and,
displaying the updated schedule via the user interface for the handheld unit.

5. A method of claim 1, further comprising the steps of:
periodically tracking geo-coded information of the handheld unit of the remote agent as the remote agent visits the target locations;
verifying at least one visitation by the remote agent of the visited locations based on the tracked geo-coded information of the handheld unit, wherein the verification is performed by the remote activity manager.

6. A method of claim 5, further comprising the steps of:
comparing the schedule and the tracked geo-coded information of the handheld unit, wherein the comparison is performed by the remote activity manager; and,
generating a report of variances between the schedule and the tracked geo-coded information of the handheld unit, wherein the report is generated by the remote activity manager.

7. A method of claim 1, further comprising the steps of:
generating a route based on the schedule, wherein the route provides directions to at least one of the target locations, and
transmitting the route to the handheld unit of the remote agent, wherein the route is transmitted by the remote activity manager; and,
displaying the route via the user interface for the handheld unit.

8. A method of claim 1, wherein the remote agent is a marketer, and wherein the target locations are places where the marketer meets with contacts to conduct business.

9. A method of claim 1, further comprising the steps of:
receiving, via the remote activity manager, remote location information from a source of remote locations.

10. A method of claim 9, further comprising the steps of:
consolidating the remote location information and the schedule.

11. A method of claim 1, wherein the scheduling engine prioritizes the target locations based on the pre-determined business rules and the contact parameters for the target locations, wherein the schedule is partially based on the prioritized target locations.

12. A method of claim 1, wherein the step of generating a schedule further comprises the steps of:
establishing an anchor point based geo-coded information of the handheld unit of the remote agent; and,
optimizing the schedule partially based on travel information selected from the group consisting of: a travel time between the anchor point and the target locations, and a geographic proximity to the anchor point.

13. A method of claim 4, wherein the step of generating an updated schedule further comprises the steps of:
establishing an anchor point based the geo-coded information of the handheld unit of the remote agent; and,
optimizing the updated schedule partially based on travel information selected from the group consisting of: a travel time between the anchor point and the target locations, and a geographic proximity to the anchor point.

14. A method of claim 13, wherein the anchor point is established daily.

15. A method of claim 1, wherein the step of generating a schedule is automatically performed daily.

16. A method of claim 2, further comprising the step of:
determining the corresponding visit frequencies based on a plurality of contact characteristics selected from the group consisting of referral patterns, specialties, key dates, and contact requests.

17. A method of claim 2, further comprising the step of:
determining corresponding visit frequencies based on referral patterns.

18. A method of claim 17, wherein the step of determining the corresponding visit frequencies based on the referral patterns further comprises the steps of:
obtaining a list of contacts from a source of remote locations, wherein the list of contacts is based on a quantity of referrals;
assigning a top tier visit frequency to contacts in top tier of the list;
assigning the top tier visit frequency to contacts with a decrease in the quantity of referrals, wherein the decrease is determined by a referral trend over a given period of time;
assigning the top tier visit frequency to new contacts on the list, wherein new contact assignment continues for a limited period of time, wherein the new contacts are reassigned a visit frequency after the limited period of time based the referral patterns;
assigning a second tier visit frequency to contacts in a second tier of the list;
assigning a third tier visit frequency to contacts in a third tier of the list; and,
assigning the third tier visit frequency to non-referring contacts on the list, wherein non-referring contacts have zero referrals.

19. A method of claim 18, wherein the top tier visit frequency contacts are visited once per week; wherein the second tier visit frequency contacts are visited twice per month; and, wherein the third tier visit frequency contacts are visited once per month.

20. A method of claim 18, wherein the top tier visit frequency contacts are visited more often than the second tier visit frequency contacts; and, wherein the second tier visit frequency contacts are visited more often than the third tier visit frequency contacts.

21. A method of claim 17, wherein the step of determining the corresponding visit frequencies based on the referral patterns further comprises the steps of:
assigning at least one of the contacts a priority level based on a quantity of referrals for the corresponding at least one of the contacts.

22. A method of claim 21, wherein the priority level is selected from a set of priority levels, and wherein the set of priority levels is based on the number of business days per year.

23. A method of claim 2, further comprising the step of:
determining corresponding visit frequencies based on specialties.

24. A method of claim 23, wherein the step of determining the corresponding visit frequencies based on the specialties further comprises the steps of:
obtaining a list of contacts from a source of remote locations, wherein the list of contacts is based on a contact specialty;
assigning a top priority tier visit frequency to contacts having a top priority tier contact specialty, wherein the top priority tier contact specialty is based on a determination of potential business; and,
assigning a low tier visit frequency to contacts having in a low tier contact specialty, wherein the low tier contact specialty is based on the determination of potential business.

25. A method of claim 24, wherein the top priority tier visit frequency contacts are visited once per week, and wherein the lows tier visit frequency contacts are visited once per month.

26. A method of claim 2, further comprising the step of:
determining corresponding visit frequencies based on key dates.

27. A method of claim 26, wherein the step of determining the corresponding visit frequencies based on the key dates further comprises the steps of:
assigning a special date to contacts based on a date selected from a group consisting of an anniversary date, a birthday date, and a special occasion date, wherein the special date is collected via the user interface, wherein the remote agent is scheduled to visit the contacts on the special date; and,
assigning a requested return visit date to the contacts based on a return date selected from a group consisting of a vacation date and an availability date, wherein the return date is collected via the user interface, wherein the remote agent is scheduled to visit the contacts on the return date.

28. A method of claim 2, further comprising the step of:
determining corresponding visit frequencies based on contact requests.

29. A method of claim 28, wherein the step of determining the corresponding visit frequencies based on the contact requests further comprises the steps of:
assigning the contact requests to the contacts based on a request selected from a group consisting of a increase visit frequency request and a decrease visit frequency request, wherein the contact requests are collected via the user interface; and,
transmitting, via the remote activity manager, the contact requests to a system administer for review.

30. A method of claim 1, further comprising the step of:
receiving, via the remote activity manager, the contact parameters from a source of remote locations.

31. A method of claim 1, further comprising the step of:
receiving, via the remote activity manager, the geo-coded information from a source of geo-coded information.

32. A method of claim 1, further comprising the step of:
transmitting, via the remote activity manager, the contact parameters and the geo-coded information to the scheduling engine.

33. A method of claim 1, further comprising the step of:
receiving, via the remote activity manager, the schedule from the schedule engine.

34. A method of claim 1, wherein the step of generating the target locations is further based on specialties.

35. A method of claim 1, wherein the step of generating a schedule further comprises the steps of:
assigning, via the remote activity manager, a contact status to the contacts, wherein the contact status is selected from the group consisting of customer status and prospect status; and,
optimizing the schedule partially based on the contact status.

36. A method of claim 1, wherein each of the contacts are prospective clients.

37. A method of claim 1, wherein each of the contacts are current clients.

38. A method of claim 1, wherein the handheld unit of the remote agent is a device selected from a group consisting of a personal digital assistant, a Blackberry, a Palm Pilot, a tablet and a laptop.

39. A method of claim 1, wherein the remote locations are healthcare provider locations.

40. A method of claim 1, further comprising the step of:
determining the contact parameters for the target locations based on contact characteristics of the contacts, wherein the contact characteristics is selected from the group of business relationships consisting of: a no prior business relationship; a new business relationship; a consistent business relationship; a increasing business relationship; a decreasing business relationship; a last business relationship; a loyal business relationship; a discount business relationship; a impulse business relationship; a wandering business relationship; a dissatisfied business relationship; an indecisive business relationship; a base business relationship; a satisfied business relationship; a referred business relationship; a contracted business relationship; a rare business relationship; and, a need based business relationship.

41. A system for directing the activities of remote agents comprising:
a remote activity manager adapted to generate target locations based on geo-coded information of remote locations, wherein the target locations are locations having contacts, wherein the target locations are a subset of the remote locations;
a scheduling engine adapted to generate a schedule based on pre-determined business rules, contact parameters for the target locations, and the geo-coded information, wherein the contact parameters are based on contact characteristics of the contacts;
a handheld unit adapted to receive the schedule, wherein the handheld unit is a programmable device comprising a GPS receiver, wherein the remote activity manager is further adapted to communicate with the handheld unit via a long range wireless network, wherein the remote activity manager is further adapted to transmit the schedule to the handheld unit; and,
a user interface adapted to display the schedule on the handheld unit.

42. A system of claim 41, wherein the remote activity manager is further adapted to receive the contact parameters from a source of remote locations.

43. A system of claim 41, wherein the remote activity manager is further adapted to receive the geo-coded information from a source of geo-coded information.

44. A system of claim 41, wherein the remote activity manager is further adapted to transmit the contact parameters and the geo-coded information to the scheduling engine.

45. A system of claim 41, wherein the scheduling engine is further adapted to transmit the schedule to the remote activity manager.

46. A system of claim 41, wherein the remote activity manager is further adapted to receive remote location information from a source of remote locations.

47. A system of claim 41, wherein the remote activity manager is further adapted to transmit remote location information to the handheld unit.

48. A system of claim 41, wherein the handheld unit is further adapted to track, at predetermined intervals, geo-coded information of the handheld unit; and wherein the handheld unit is further adapted to transmit the geo-coded information of the handheld unit to the remote activity manager, whereby the handheld unit tracks the location of the handheld unit thereby allowing the remote activity manager to verify the visit information.

49. A system of claim 41, wherein the handheld unit is further adapted to receive visit information, and wherein the handheld unit is further adapted to transmit the visit information to the remote activity manager, whereby the schedule is presented to the remote agent on the handheld unit and the remote agent provides visit information via the handheld unit.

50. A system of claim 41, further adapting the system such that the remote agents are marketers and the target locations are places to be visited by the marketers.

51. A system of claim 41, wherein the remote activity manager is further adapted to determine the contact parameters based on contact characteristics of the contacts, wherein the contact parameters include corresponding visit frequencies.

52. A system of claim 41, wherein the scheduling engine is further adapted to update the schedule based on pre-determined business rules, updated contact parameters, updated geo-coded information of the handheld unit, and the geo-coded information of the remote locations, and wherein the scheduling engine is further adapted to transmit the updated schedule to the handheld unit of the remote agent; and wherein the handheld unit is further adapted to display the updated schedule via the user interface.

53. A system of claim 41, wherein the scheduling engine is further adapted to generate a route based on the schedule, wherein the route provides directions to at least one of the target locations, wherein the remote activity manager is further adapted to transmit the route to the handheld unit of the remote agent, wherein the handheld unit is further adapted to display the route via the user interface.

54. A system of claim 41, wherein the scheduling engine is further adapted to establish an anchor point based geo-coded information of the handheld unit of the remote agent, and wherein the scheduling engine is further adapted to optimize the schedule partially based on travel information selected from the group consisting of: a travel time between the anchor point and the target locations, and a geographic proximity to the anchor point.

55. A system of claim 41, wherein the source of remote locations is a billing system adapted to maintain information relating to referrals from contacts at the target locations.

56. A system of claim 41, wherein the contact parameters include corresponding visit frequencies, and wherein the corresponding visit frequencies are based on a plurality of contact characteristics selected from the group consisting of referral patterns, specialties, key dates, and contact requests.

57. A first and second computer-usable medium having computer readable instructions stored thereon for execution by a processor, wherein:
(a) the instructions on the first medium are adapted to
execute on a system comprising a scheduling engine;
provide target locations having contacts to the scheduling engine;
provide geo-coded information of remote locations to the scheduling engine;
generate, via the scheduling engine, a schedule based on pre-determined business rules, contact parameters for the target locations, and the geo-coded information, wherein the contact parameters are based on contact characteristics of the contacts;
provide the schedule to a remote activity manager;
provide the schedule and geo-coded information to a handheld unit, wherein the remote activity manager communicates with the handheld unit via a long range wireless network;
receive, from the handheld unit, visit information and tracked geo-coded information of the handheld unit; and
(b) the instructions on the second medium are adapted to
execute on the handheld unit;
receive the schedule and the geo-coded information;
display the schedule and the geo-coded information via a use interface;
receive visit information from the remote agent;
track geo-coded information of the handheld unit at predetermined intervals; and
transmit visit information and tracked geo-coded information to the remote activity manager.

58. A method of claim 12, wherein the anchor point is established daily.
